(19) United States
(12) Patent Application Publication
(10) Pub. No.: US 2019/0087620 A1
(43) Pub. Date: Mar. 21, 2019

(54) GAMMA CIRCUIT SUPPORTING OPTICAL FINGERPRINT RECOGNITION, ELECTRONIC DEVICE INCLUDING THE SAME AND METHOD OF PERFORMING OPTICAL FINGERPRINT RECOGNITION

(71) Applicant: SAMSUNG ELECTRONICS CO., LTD., Suwon-si (KR)

(72) Inventors: Jee-Hwal Kim, Seoul (KR); Seung-Jae LEE, Suwon-si (KR); Dong-Hui Kim, Hwaseong-si (KR); Hong-Kook Lee, Seoul (KR)

(21) Appl. No.: 15/943,870

(22) Filed: Apr. 3, 2018

(30) Foreign Application Priority Data
Sep. 21, 2017 (KR) 10-2017-0121749

(51) Int. Cl. G06K 9/00; H04N 5/202; G09G 3/20

(52) U.S. Cl. CPC G06K 9/0002; G09G 2310/0264; G09G 3/20; H04N 5/202

(57) ABSTRACT

An electronic device includes a display panel, a gamma circuit, a driving circuit, and a fingerprint recognition sensor. The gamma circuit generates a first set of gray voltages in a normal operation mode and a fingerprint recognition voltage corresponding to a brightness higher than a maximum gray voltage among the first set of gray voltages. The driving circuit displays an image on the display panel based on the first set of gray voltages in the normal operation mode and a fingerprint recognition window on a portion of the display panel based on the fingerprint recognition voltage in the fingerprint recognition mode. The fingerprint recognition sensor recognizes a fingerprint based on reflected light of the fingerprint received through the fingerprint recognition window.

### CROSS-REFERENCE TO RELATED APPLICATION

Korean Patent Application No. 10-2017-0121749, filed on Sep. 21, 2017, and entitled, “Gamma Circuit Supporting Optical Fingerprint Recognition, Electronic Device Including the Same and Method of Performing Optical Fingerprint Recognition,” is incorporated by reference herein in its entirety.

### BACKGROUND

### 1. Field

One or more embodiments described herein relate to a gamma circuit supporting optical fingerprint recognition, an electronic device including a gamma circuit, and a method for performing optical fingerprint recognition.

### 2. Discussion of the Related Art

Biometric information is widely used in personal authentication because of its invariability and uniqueness. One type of biometric information is a fingerprint. Fingerprint recognition may be performed conveniently and serves as an excellent way of determining the identity of a person. Optical fingerprint recognition obtains a fingerprint image based on differences in light reflected by ridges and valleys of a finger. However, obtaining an accurate fingerprint image has proven to be difficult because the differences in reflected light tends to be very small.

### SUMMARY

In accordance with one or more embodiments, an electronic device includes a display panel including a plurality of pixels; a gamma circuit to generate a first set of gray voltages in a normal operation mode and to generate a fingerprint recognition voltage corresponding to a brightness higher than a maximum gray voltage among the first set of gray voltages; a driving circuit to display an image on the display panel based on the first set of gray voltages in the normal operation mode and to display a fingerprint recognition window on a portion of the display panel based on the fingerprint recognition voltage in the fingerprint recognition mode; and a fingerprint recognition sensor to recognize a fingerprint based on reflected light of the fingerprint received through the fingerprint recognition window.

In accordance with one or more other embodiments, a gamma circuit for generating gray voltages to drive a display panel includes a generator to generate a first set of gray voltages in a normal operation mode and a second set of gray voltages and a fingerprint recognition voltage in the fingerprint recognition mode, wherein the fingerprint recognition voltage corresponds to a brightness higher than a maximum gray voltage among the first set of gray voltages in the fingerprint recognition mode.

In accordance with one or more other embodiments, a method for performing optical fingerprint recognition generating a plurality of gray voltages to display an image on a display panel based on the plurality of gray voltages in a normal operation mode; generating a fingerprint recognition voltage corresponding to a brightness higher than a maximum gray voltage among the first set of gray voltages in a fingerprint recognition mode; displaying a fingerprint recognition window on a portion of the display panel based on the fingerprint recognition voltage in the fingerprint recognition mode; and recognizing a fingerprint based on a reflection light of the fingerprint received through the fingerprint recognition window.

### BRIEF DESCRIPTION OF THE DRAWINGS

Features will become apparent to those of skill in the art by describing in detail exemplary embodiments with reference to the attached drawings in which:

FIG. 1 illustrates a flow chart of a method for optical fingerprint recognition according to an embodiment;

FIG. 2 illustrates a block diagram an embodiment of an electronic device;

FIG. 3 illustrates a circuit diagram an embodiment of a pixel of a display panel;

FIG. 4 illustrates an embodiment of a mobile device;

FIGS. 5 and 6 illustrate examples of gray voltages and a fingerprint recognition voltage according to embodiments;

FIG. 7 illustrates a circuit diagram of a gamma circuit according to an embodiment;

FIG. 8 illustrates a block diagram of a gamma reference voltage generator corresponding to the gamma circuit of FIG. 7;

FIG. 9 illustrates a circuit diagram of a gamma circuit according to an embodiment;

FIG. 10 illustrates a block diagram of a data driver according to an embodiment;

FIG. 11 illustrates an example representing a location of a fingerprint recognition window and the location of a pixel;

FIG. 12 illustrates a flow chart of a method for displaying a fingerprint recognition window according to an embodiment;

FIG. 13 illustrates a diagram for describing driving voltages of a display panel in a normal operation mode and a fingerprint recognition mode according to embodiments;

FIG. 14 illustrates a plot of gray voltages and a fingerprint recognition voltage according to embodiments;

FIG. 15 illustrates a circuit diagram of a gamma circuit according to an embodiment;

FIG. 16 illustrates a block diagram embodiment of a gamma reference voltage generator corresponding to the gamma circuit of FIG. 15;

FIG. 17 illustrates a circuit diagram of a gamma circuit according to an embodiment;

FIG. 18 illustrates a block diagram of a gamma reference voltage generator corresponding to the gamma circuit of FIG. 17;

FIG. 19 illustrates a circuit for processing display data according to an embodiment;

FIG. 20 illustrates a block diagram of a data driver according to an embodiment;

FIG. 21 illustrates a diagram for describing driving voltages of a display panel in a normal operation mode and a fingerprint recognition mode according to embodiments; and

FIG. 22 illustrates a block diagram of an electronic device according to embodiment.

### DETAILED DESCRIPTION

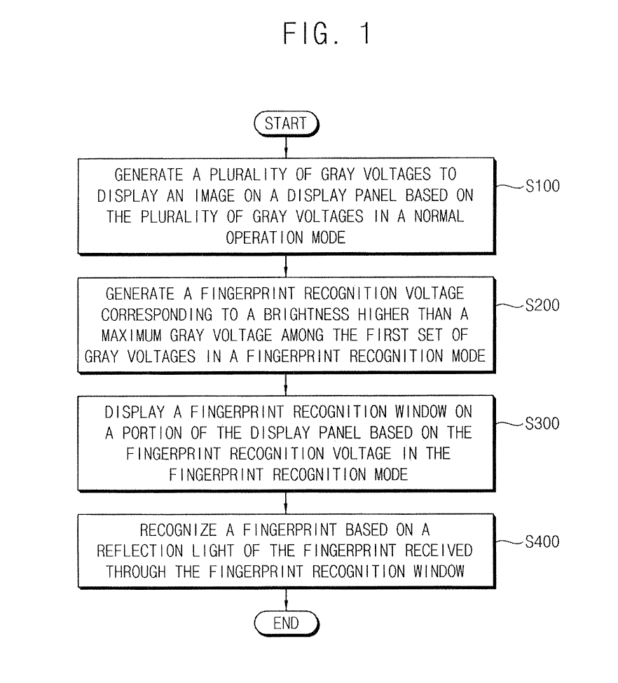

FIG. 1 illustrates an embodiment of a method for performing optical fingerprint recognition. Referring to FIG. 1, the method includes generating a plurality of gray voltages to display an image on a display panel based on the plurality of gray voltages in a normal operation mode (S100). A plurality of gamma reference voltages may be generated, and the plurality of gray voltages for representing a plurality of gray values of display data may be generated based on the plurality of gamma reference voltages.

The plurality of gamma reference voltages may be determined, for example, through a multi-time programmable (MTP) operation. When the display device is manufactured, an image quality of an end product (e.g., complete product) of the display device may not reach a target quality level because of deviations in a manufacturing process. In this case, the end product may be a defective product to be discarded.

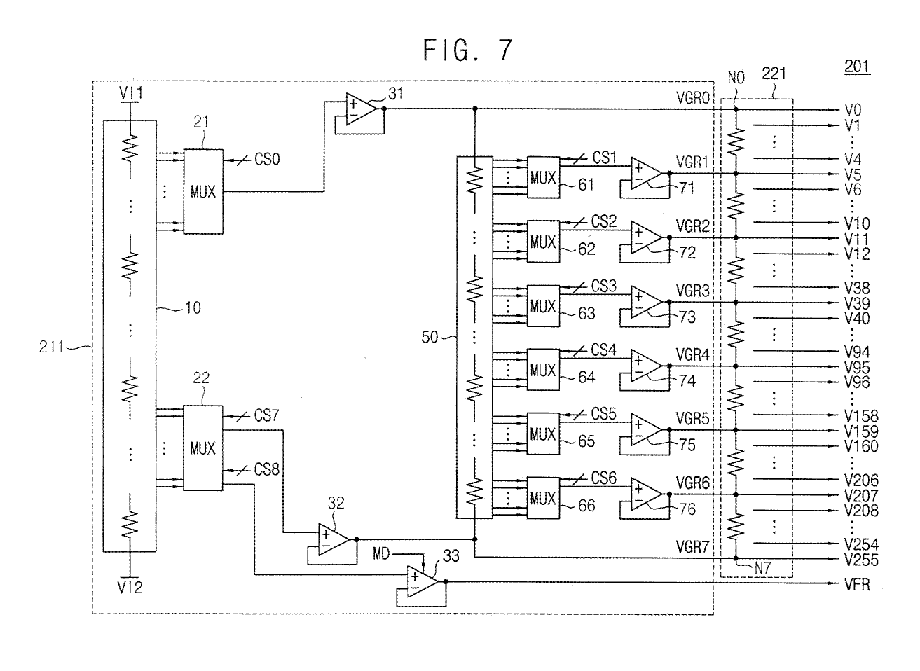

However, discarding all end products determined as defective products is not efficient. Therefore, a post-correction operation for adjusting the image quality of the display device to reach the target quality level may be performed. In this case, the MTP operation may repeatedly perform the post-correction operation in luminance and color coordinates for respective pixel circuits in order to adjust the image quality of the display device to reach the target quality level. The MTP operation may be performed by storing respective gamma offsets based on comparison between a reference gamma curve and respective actual gamma curves that are generated based on a pixel gamma curve. The gamma offsets may correspond, for example, to values of selection signals CS0˜CS8 as set forth in FIG. 7.

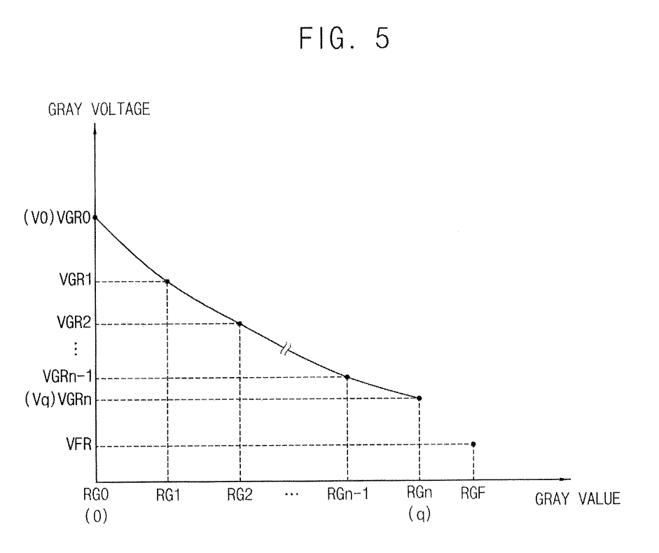

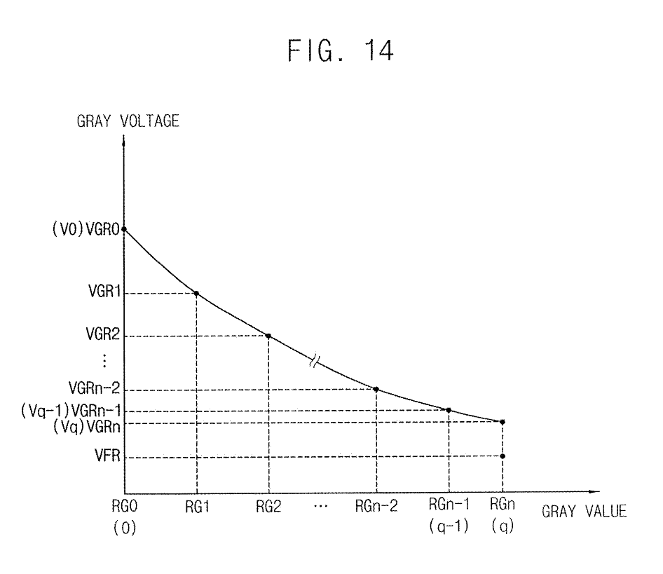

A fingerprint recognition voltage, corresponding to a brightness higher than a maximum gray voltage among the first set of gray voltages, is generated in a fingerprint recognition mode (S200). In some example embodiments, the fingerprint recognition voltage may be a distinct voltage that is provided independently of the maximum gray voltage, for example, as described with reference to FIGS. 5 to 13. In other example embodiments, the fingerprint recognition voltage may be provided by adjusting the level of the maximum gray voltage as described with reference to FIGS. 14 to 21.

A fingerprint recognition window is displayed on a portion of the display panel based on the fingerprint recognition voltage in the fingerprint recognition mode (S300). In some example embodiments, only the fingerprint recognition window may be displayed on the display panel and the image may not be displayed in a portion other than the fingerprint recognition window of the display panel in the fingerprint recognition mode. In other example embodiments, the fingerprint recognition window may be displayed on the display panel and, simultaneously, the image may be displayed in the portion other than the fingerprint recognition window of the display panel in the fingerprint recognition mode. A fingerprint may be recognized based on reflected light received through the fingerprint recognition window (S400).

When brightness of the image is increased, power consumption may also be increased. The brightness of the image may not always be high (e.g., above a predetermined level). In one embodiment, the brightness of the image may be controlled according to the choice of a user (e.g., user information or a user selection signal), the form of image, and/or other information.

In accordance with one or more embodiments, the electronic device and the method for performing optical fingerprint recognition may increase the intensity of light reflected by a fingerprint and may increase the resolution of a fingerprint image by displaying the fingerprint recognition window of higher brightness using the fingerprint recognition voltage.

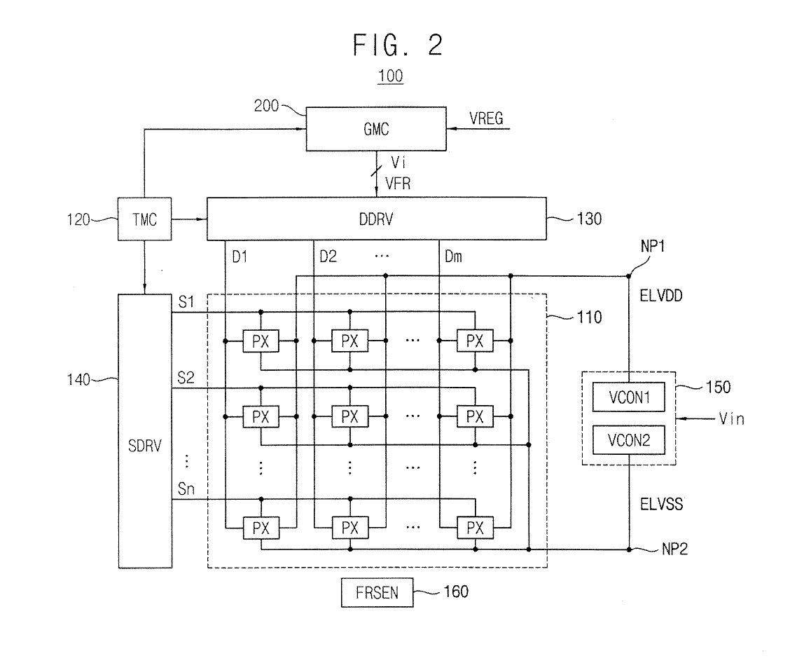

FIG. 2 illustrates an embodiment of an electronic device 100 which may include a display panel 110, a timing controller TMC 120, a data driver DDRV 130, a scan driver SDRV 140, a power supply circuit 150, a fingerprint recognition sensor FRSEN 160, and a gamma circuit GMC 200. In one embodiment, the electronic device 100 may further include a buffer for storing image data to be displayed and/or other features.

The display panel 110 includes a plurality of pixels PX or pixel circuits arranged in rows and columns. For example, the pixels PX may be arranged in a matrix form of n rows and m columns as illustrated in FIG. 2. The display panel 110 is connected to the data driver 130 through data lines D1˜Dm and to the scan driver 140 through scan lines S1˜Sn. The display panel 110 is connected between a first power node NP1 and a second power node NP2 and powered by the power supply circuit 150.

The power supply circuit 150 may operate based on control signals. At least a portion of the control signals may be provided from the timing controller 120. The power supply circuit 150 may include a first voltage converter VCON1 and a second voltage converter VCON2. An input voltage Vin provided to the power supply circuit 150 may be a direct current (DC) voltage such as a battery voltage. The first and second voltage converters VCON1 and VCON2 may be DC-DC converters. The first voltage converter VCON1 generates a first power supply voltage ELVDD, having a positive voltage level based on the input voltage Vin, to drive the first power node NP1 with the first power supply voltage ELVDD. The second voltage converter VCON2 generates a second power supply voltage ELVSS, having another (e.g., negative) voltage level or a ground voltage based on the input voltage Vin, to drive the second power node NP2 with the second power supply voltage ELVSS.

The gamma circuit 200 may generate a plurality of gamma reference voltages Vi and a fingerprint recognition voltage VFR based on a regulator voltage VREG. In some example embodiments, the regulator voltage VREG may be the first power supply voltage ELVDD itself or another voltage generated based on the first power supply voltage ELVDD.

The gamma circuit 200 may generate a first set of gray voltages in a normal operation mode and may generate the fingerprint recognition voltage VFR corresponding to a brightness higher than a maximum gray voltage among the first set of gray voltages. Example embodiments of the gamma circuit 200 will be described below.

The data driver 130 may provide data signals to the display panel 110 to the data lines D1˜Dm. The data driver 130 may generate a plurality of gray voltages based on the gamma reference voltages Vi and may drive the data lines D1˜Dm based on display data, the fingerprint recognition voltage VFR and the gray voltages Vi.

The scan driver 140 may provide row control signals to the display panel 110 through the scan lines S1˜Sn. The pixels PX may be at locations where the data lines D1˜Dm and the scan lines S1˜Sn cross. The timing controller 120 may control overall operations of the electroluminescent display 100. The timing controller 120 may provide control signals to control the display panel 110, the data driver 130, the scan driver 140, the power supply circuit 150, and the gamma circuit 200.

In some embodiments, the timing controller 120, the data driver 130, the scan driver 140, the power supply circuit 150, and the gamma circuit 200 may be implemented as a single integrated circuit (IC). In other embodiments, the timing controller 120, the data driver 130, the scan driver 140, the power supply circuit 150 and the gamma circuit 200 may be implemented as two or more ICs.

The timing controller 120, the data driver 130, the scan driver 140, and the power supply circuit 150 correspond to a driving circuit to drive the display panel 110. The driving circuit may display an image on the display panel 110 based on a first set of gray voltages in the normal operation mode and display a fingerprint recognition window on a portion of the display panel 110 based on the fingerprint recognition voltage VFR in the fingerprint recognition mode. In some example embodiments, the gamma circuit 200 may further generate a second set of gray voltages in the fingerprint recognition mode, and the driving circuit may display an image on a portion other than the fingerprint recognition window of the display panel 110 based on the second set of gray voltages in the fingerprint recognition mode.

In some example embodiments, as will be described below with reference to FIG. 5, the second set of gray voltages may be identical to the first set of gray voltages. In other example embodiments, as will be described, for example, with reference to FIG. 14, the second set of gray voltages may be different from the first set of gray voltages.

The fingerprint recognition sensor 160 may recognize a fingerprint based on a reflection light received through the fingerprint recognition window. The fingerprint recognition sensor 160 may include an image sensor to capture the fingerprint image and a microprocessor to processing fingerprint image data.

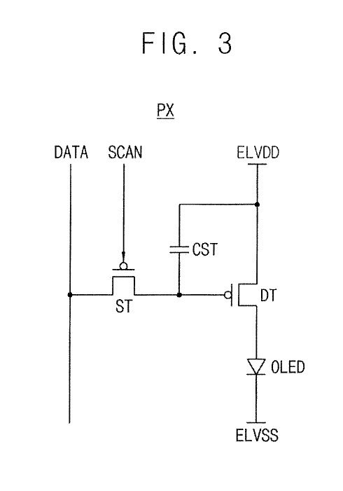

FIG. 3 is a circuit diagram illustrating an example of a pixel included in a display panel in the electronic device of FIG. 2.

Referring to FIG. 3, each pixel PX may include a switching transistor ST, a storage capacitor CST, a driving transistor DT, and an organic light-emitting diode (OLED). For example, Each of a red sub pixel R, a green sub pixel G and a blue sub pixel B may have the configuration as illustrated in FIG. 3.

The switching transistor ST includes a first source/drain terminal connected to a data line, a second source/drain terminal connected to the storage capacitor CST, and a gate terminal connected to the scan line. The switching transistor ST transfers a data signal DATA received from the data driver 130 to the storage capacitor CST based on a scan signal SCAN received from the scan driver (also referred to as “gate driver”) 140.

The storage capacitor CST has a first electrode connected to a high power supply voltage ELVDD and a second electrode connected to a gate terminal of the driving transistor DT. The storage capacitor CST stores the data signal DATA transferred through the switching transistor ST.

The driving transistor DT has a first source/drain terminal connected to the high power supply voltage ELVDD, a second source/drain terminal connected to the OLED, and the gate terminal connected to the storage capacitor CST. The driving transistor DT is turned on or off according to the data signal DATA stored in the storage capacitor CST.

The OLED has an anode electrode connected to the driving transistor DT and a cathode electrode connected to a low power supply voltage ELVSS. The OLED emits light based on a current flowing from the high power supply voltage ELVDD to the low power supply voltage ELVSS while the driving transistor DT is turned on. The brightness of the pixel PX may be increased as the current flowing through the OLED is increased.

Even though FIG. 3 illustrates the OLED pixel as an example of a pixel that may be included in the display panel 110, it would be understood that the fingerprint recognition according to example embodiments is not limited to the OLED pixel and example embodiment in this disclosure may be applied to any pixels of various types and configurations.

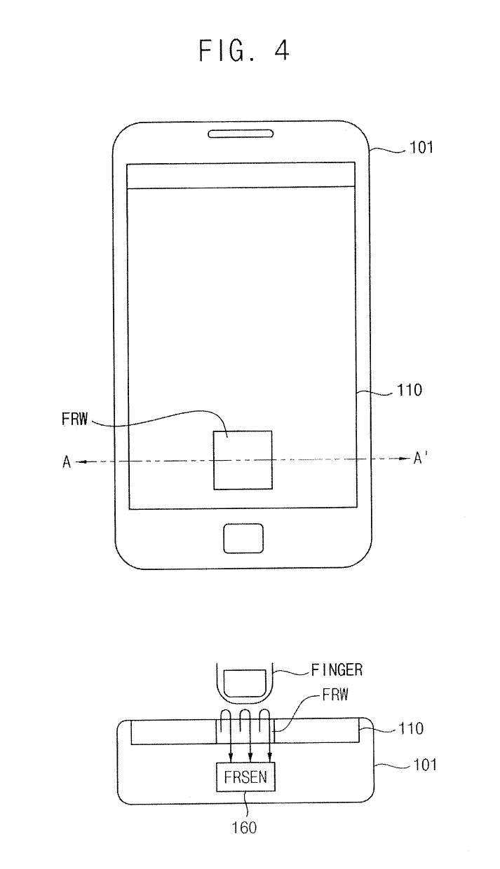

FIG. 4 is a diagram illustrating a mobile device performing optical fingerprint recognition according to example embodiments. A mobile device 101 such as a smart phone is illustrated in an upper portion of FIG. 4 and a cross-sectional view of the mobile device 101 along a cutting line A-A′ is illustrated in a lower portion of FIG. 4.

Referring to FIG. 4, a fingerprint recognition window FRW may be displayed on a portion of a display panel 110 based on the fingerprint recognition voltage VFR in the fingerprint recognition mode. As described above, the fingerprint recognition voltage corresponds to a brightness higher than a maximum gray voltage among the first set of gray voltages.

The fingerprint recognition sensor 160 is disposed under the display panel 110 such that the fingerprint recognition sensor 160 may overlap the fingerprint recognition window FRW in the vertical direction. When a user put a finger on the fingerprint recognition window FRW, the light generated from the pixels of the fingerprint recognition window FRW is reflected by a fingerprint of the finger and the reflected light is provided to the fingerprint recognition sensor 160. The fingerprint recognition sensor 160 may capture the fingerprint image based on the reflection light received through the fingerprint recognition window FRW.

A electroluminescent display device may be drive with rapid response speed and low power consumption using a light emitting diode (LED) or an organic light emitting diode (OLED) that generates light by recombination of electrons and holes. In comparison with a liquid crystal display device using a backlight unit, the pixel of the electroluminescent display device emits light and a reflection layer is disposed beneath the display panel 110 to enhance brightness of display image. The reflection light of the fingerprint to the fingerprint recognition sensor 160 is decreased significantly due to the reflection layer, and it is not easy to obtain an exact fingerprint image.

According to example embodiments, intensity of the reflection light of the fingerprint and resolution of a fingerprint image may be increased by displaying the fingerprint recognition window FRW of higher brightness.

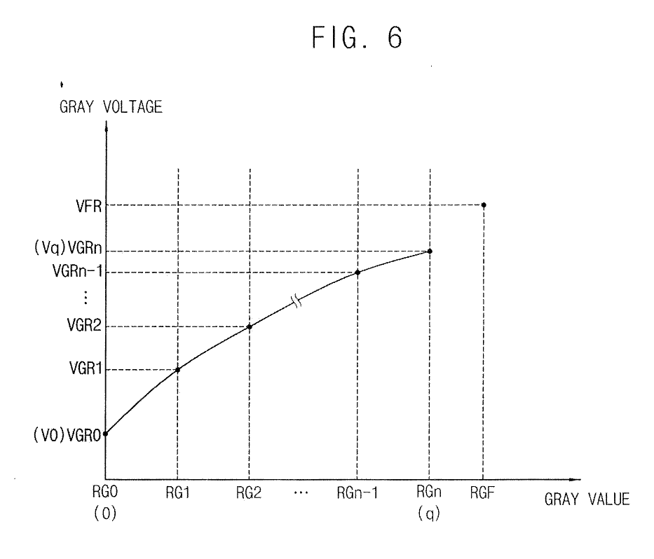

FIGS. 5 and 6 are diagrams illustrating gray voltages and a fingerprint recognition voltage according to example embodiments.

FIGS. 5 and 6 illustrate graphs to compare the fingerprint recognition voltage VFR with gray voltages corresponding to a minimum gray value “0” to a maximum gray value “q”.

Referring to FIG. 5, in some example embodiments, the gray voltage may decrease as the gray value increases. In other words, a minimum gray voltage V0 corresponding to a minimum brightness may have a highest voltage level and the maximum gray voltage Vq corresponding to a maximum brightness may have a lowest voltage level. For example, in case of the Pixel PX of FIG. 3, the driving transistor DT may be implemented with a p-type metal oxide semiconductor (PMOS) transistor. In this case, the current flowing through the OLED may increase as the data signal DATA or the gray voltage applied to the gate electrode of the driving transistor DT decreases. Accordingly the lower gray voltage may represent the higher gray value or the higher brightness.

A plurality of reference gray values RG0˜RGn may be selected among a plurality of gray values 0˜q and a plurality of gamma reference voltages VGR0˜VGRn corresponding to the plurality of reference gray values RG0˜RGn may be determined. A plurality of gray voltages corresponding to the plurality of gray values 0˜q may be provided based on the plurality of gamma reference voltages VGR0˜VGRn.

The gamma circuit 200 included in the electronic device 100 of FIG. 2 may generate the plurality of gamma reference voltages VGR0˜VGRn common to the normal operation mode and the fingerprint recognition mode, and generate the first set of gray voltages V0˜Vq in the normal operation mode and the second set of gray voltages V0˜Vq in the fingerprint recognition mode by dividing the plurality of gamma reference voltages VGR0˜VGRn.

The fingerprint recognition voltage VFR corresponding to a brightness higher than the maximum gray voltage VGRn may correspond to a gray value RGF higher than the maximum gray value of the display image. The fingerprint recognition voltage VFR may be determined independently of the gray voltages V0˜Vq. As a result, the first set of gray voltages V0˜Vq and the second set of gray voltages V0˜Vq may be identical regardless of the operation mode.

As such, the electronic device and the method of performing optical fingerprint recognition according to example embodiments may increase resolution of a fingerprint image without degradation of a display image, by displaying the fingerprint recognition window FRW of higher brightness using the fingerprint recognition voltage VFR while maintaining the other gray voltages V0˜Vq.

Referring to FIG. 6, in some example embodiments, the gray voltage may increase as the gray value increases. In other words, a minimum gray voltage V0 corresponding to a minimum brightness may have a lowest voltage level and the maximum gray voltage Vq corresponding to a maximum brightness may have a highest voltage level. For example, a driving transistor of a pixel may be implemented with a n-type metal oxide semiconductor (NMOS) transistor connected between a cathode electrode of an OLED and a low power supply voltage ELVSS. In this case, the current flowing through the OLED may increase as the data signal DATA or the gray voltage applied to the gate electrode of the driving transistor DT increases. Accordingly the higher gray voltage may represent the higher gray value or the higher brightness.

As described with reference to FIGS. 5 and 6, the gray value or the brightness may decrease or increase as the gray voltage increases. In some example embodiments, as illustrated in FIG. 5, the brightness corresponding to the fingerprint recognition voltage VFR may be increased by decreasing the voltage level of the fingerprint recognition voltage VFR to lower than the maximum gray voltage Vq. In some example embodiments, as illustrated in FIG. 6, the brightness corresponding to the fingerprint recognition voltage VFR may be increased by increasing the voltage level of the fingerprint recognition voltage VFR to higher than the maximum gray voltage Vq. In at least one embodiment, the maximum gray voltage may not represent a gray voltage of the highest voltage level but a voltage level corresponding to the maximum gray value “q”. Hereinafter, example embodiments are described based on cases that the gray voltage decreases as the gray value increases. It is understood that the embodiments may be modified and applied to opposite cases where the gray voltage increases as the gray value increases.

FIG. 7 illustrates an embodiment of a gamma circuit 201 which may include a gamma reference voltage generator 211 and a gray voltage generator 221. The gamma reference voltage generator 211 may include resistor strings 10 and 50, selectors MUX 21, 22, and 61˜66 and voltage buffers 31, 32, 33, and 71˜76, which are connected, for example, as illustrated in FIG. 7, to generate a plurality of gamma reference voltages VGR0˜VGR7 and a fingerprint recognition voltage VFR. The gray voltage generator 221 may generate a plurality of gray voltages V0˜V255 by dividing the plurality of gamma reference voltages VGR0˜VGR7.

FIG. 7 illustrates that the gamma circuit 201 generates 256 gray voltages V0˜V255 corresponding to 8-bit display data. In another embodiment, the gamma circuit 201 may generate a different number the gray voltages. The number of the gray voltages may be determined, for example, depending on the bit number of the display data displayed by the display device. FIG. 7 illustrates the eight reference gray values 0, 5, 11, 39, 95, 159, 207, and 255 as an example. The number and/or values of the reference gray values may be different in other embodiments depending, for example, on characteristics of the display device.

The resistor string 10 may provide a plurality of voltages by dividing a first input voltage VI1 and a second input voltage VI2. The first input voltage VI1 and the second input voltage VI2 may be included, for example, in the regulator voltage VREG in FIG. 2. The selectors 21 and 22 may select and output the gamma reference voltages VGR0 and VGR7 and the fingerprint recognition voltage VFR corresponding to the selection signals CS0, CS7, and CS8 among the divided voltages from the resistor string 10. The gamma reference voltages VGR0 and VGR7 and the fingerprint recognition voltage VFR may be buffered by voltage buffers 31, 32, and 33, which may be omitted according to some example embodiments. The voltage buffer 33 outputting the fingerprint recognition voltage VFR may be disabled in the normal operation mode and enabled in the fingerprint recognition mode based on a mode signal MD.

As such, the fingerprint recognition voltage VFR and the maximum gamma reference voltage VGR7 corresponding to the maximum gray value V255 may be respectively generated. Thus, the same gamma reference voltages VGR0˜VGRn may be generated regardless of the operation mode. As a result, the same gray voltages V0˜V255 may be provided regardless of the operation mode.

The selectors 61˜66 may select and output the gamma reference voltages VGR1˜VGR6 corresponding to the selection signals CS1˜CS6, respectively, among the divided voltages from the resistor string 50. The gamma reference voltages VGR1˜VGR6 may be buffered by voltage buffers 71˜76, which may be omitted according to some example embodiments.

The gray voltage generator 221 may generate the plurality of gray voltages VGR1˜VGR255 by dividing the gamma reference voltages VGR0˜VGR7 using the resistor string connected between the output node N0 of the minimum gamma reference voltage VGR0 and the output node N7 of the maximum gamma reference voltage VGR7. The minimum gamma reference voltage VGR0 may be the minimum gray voltage V0 corresponding to the minimum gray value “q=0.” The maximum gamma reference voltage VGR7 may be the maximum gray voltage V255 corresponding to the maximum gray value “q=255”.

As illustrated in FIG. 7, the gamma circuit 201 may generate the gamma reference voltages VGR0˜VGR7 and the fingerprint recognition voltage VFR based on the first input voltage VI1 and the second input voltage VI2. The fingerprint recognition voltage VFR may be generated using the selector 22 for generating the maximum gamma reference voltage VGR7. Thus, the fingerprint recognition window FRW of high brightness may be displayed without additional excessive elements.

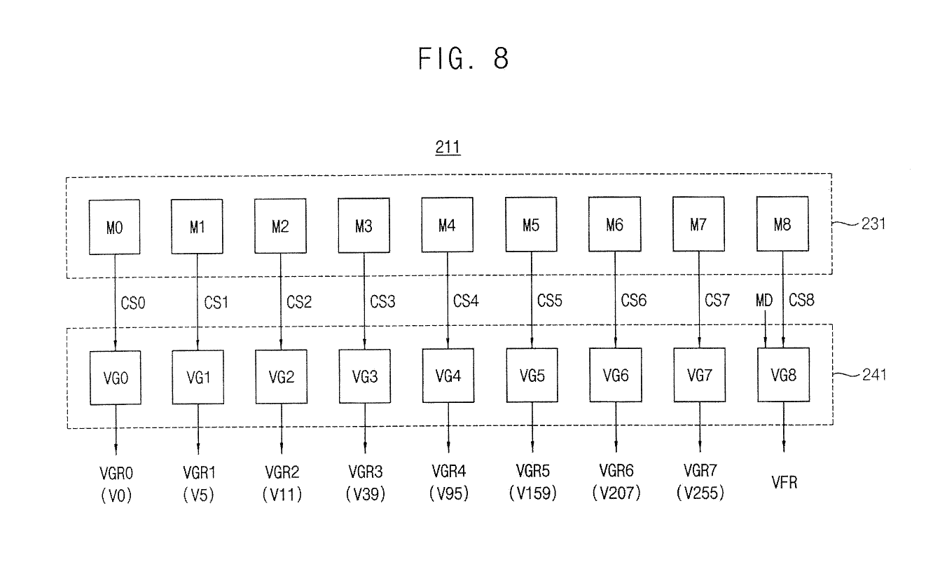

FIG. 8 illustrates an embodiment of a gamma reference voltage generator 211 corresponding to the gamma circuit of FIG. 7. Referring to FIG. 8, the gamma reference voltage generator 211 may include a storage circuit 231 and a voltage generation circuit 241. FIG. 8 illustrates eight reference gray values 0, 5, 11, 39, 95, 159, 207, and 255, corresponding selection signals CS0˜CS7, and corresponding gamma reference voltages VGR0˜VGR7 as an example. The number and/or values of the reference gray values may be different in other embodiments depending, for example, on characteristics of the display device.

The storage circuit 231 may include a plurality of memory units M0˜M8 to store values corresponding to the gamma reference voltages VGR0˜VGR7 and the fingerprint recognition voltage VFR. The voltage generation circuit 241 may include a plurality of voltage generation units VG0˜VG8 to generate the gamma reference voltages VGR0˜VGR7 and the fingerprint recognition voltage VFR based on the selection signals CS0˜CS8 from the storage circuit 231. The voltage generation units VG0˜VG8 may include resistor strings and selectors as described, for example, with reference to FIG. 7. The voltage generation unit VG8 for generating the fingerprint recognition voltage VFR may be disabled in the normal operation mode and enabled in the fingerprint recognition mode based on the mode signal MD.

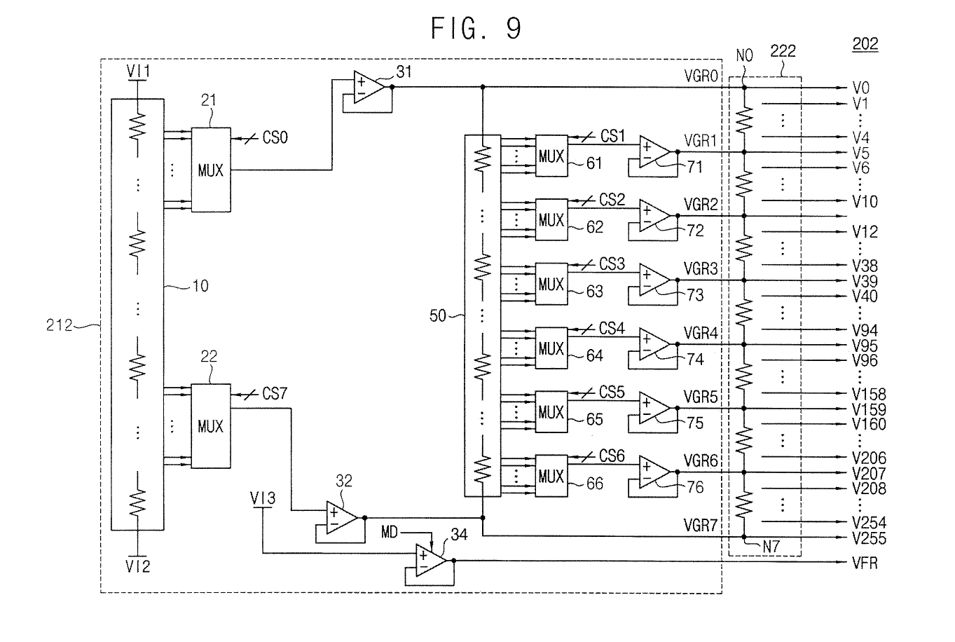

FIG. 9 illustrates another embodiment of a gamma circuit 202 which may include a gamma reference voltage generator 212 and a gray voltage generator 222. The gamma circuit 202 of FIG. 9 may be similar to the gamma circuit 201 of FIG. 7, except as follows.

The voltage buffer 33 of the gamma circuit 201 of FIG. 7 provides the fingerprint recognition voltage VFR by buffering the divided voltage from the selector 22. In contrast, the voltage buffer 34 of the gamma circuit 202 of FIG. 9 provides the fingerprint recognition voltage VFR based on a third input voltage VI3.

The gamma circuit 202 may generate the plurality of gamma reference voltages VGR0˜VGR7 based on the first input voltage VI1 and the second input voltage VI2, and may generate the fingerprint recognition voltage VFR based on the third input voltage VI3 provided independently of the first input voltage VI1 and the second input voltage VI2. In this case, the brightness of the fingerprint recognition window FRW may be adjusted efficiently by generating the fingerprint recognition voltage VFR using the independent power supply. For example, the second input voltage VI2 may be set to a ground voltage and the third input voltage VI3 may be set to a voltage having a negative voltage level. As such, the voltage level of the fingerprint recognition voltage VFR (e.g., the brightness of the fingerprint recognition window FRW) may be adjusted regardless of the gray voltages for image display.

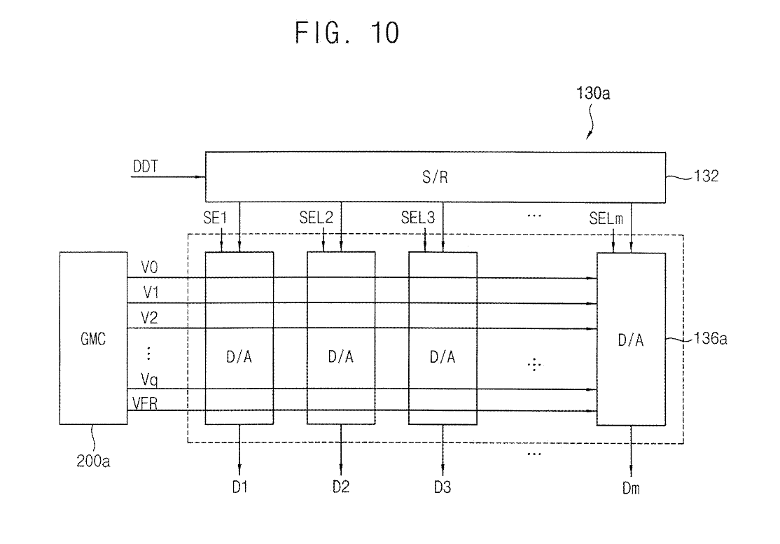

FIG. 10 illustrates another example embodiment of a data driver 130a, which, for example, may be in the electronic device of FIG. 2.

Referring to FIG. 10, a data driver 130a may include a shift register S/R 132 and a digital-to-analog converter 136a. The digital-to-analog converter 136a may include a plurality of conversion units D/A for receiving the gray voltages V0˜Vq and the fingerprint recognition voltage VFR, respectively. Each conversion unit D/A may select, among the gray voltages V0˜Vq and the fingerprint recognition voltage VFR, one gray voltage corresponding to the digital data bit received from the shift register 132 or the fingerprint recognition voltage VFR to drive the corresponding data line of the data lines D˜Dm, based on window selection signals SEL1˜SELm.

For example, when the window selection signal SELi (i=1˜m) is deactivated, the corresponding conversion unit D/A may select the one gray voltage corresponding to the digital data bit received from the shift register 132. In contrast, when the window selection signal SELi is activated, the corresponding conversion unit D/A may select the fingerprint recognition voltage VRF regardless of the digital data bit.

The shift register 132 may receive the display data DDT from the timing controller 120 in FIG. 2 and may output respective data bits of the display data DDT to the conversion units D/A corresponding to the data lines D1˜Dm, respectively.

Each of the window selection signals SEL1˜SELm represents whether or not a target pixel corresponding to a presently received data bit is in the fingerprint recognition window FRW when the fingerprint recognition window FRW is displayed in the fingerprint recognition mode. The window selection signals SEL1˜SELm may be deactivated in the normal operation mode. For example, the window selection signals SEL1˜SELm may be provided from the timing controller 120 in FIG. 2.

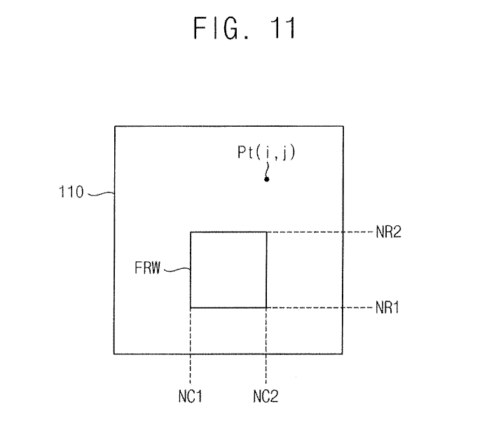

FIG. 11 illustrates an example of representing the location of a fingerprint recognition window and the location of a pixel.

Referring to FIG. 11, the location of the fingerprint recognition FRW displayed in the display panel 110 may be represented by boundary column coordinates NC1 and NC2 and boundary row coordinates NR1 and NR2. The location of the target pixel Pt to be displayed presently may be represented by a row coordinate i and a column coordinate j. Whether the target pixel is in the fingerprint recognition window FRW may be determined by comparing such coordinates. Each of the window selection signals SEL1˜SELm may be activated or deactivated based on the comparison results.

As such, the data driver 130a may display the fingerprint recognition window FRW based on the location of the fingerprint recognition window FRW and the location of the target pixel, among the plurality of pixels, in the fingerprint recognition mode.

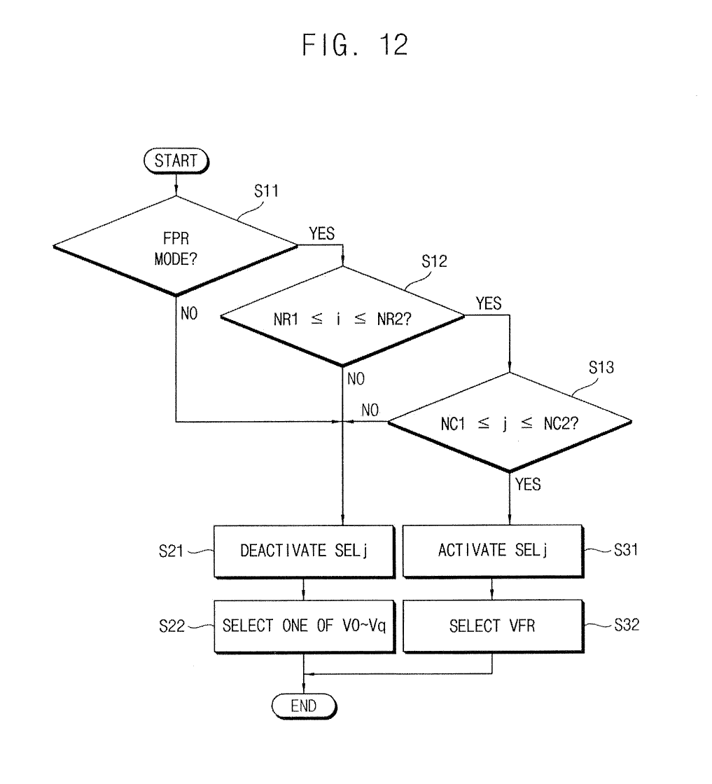

FIG. 12 illustrates an example embodiment for displaying a fingerprint recognition window. Referring to FIGS. 2, 10, 11, and 12, the timing controller 120 may determine whether a present operation mode is a fingerprint recognition mode FPR (S11). The timing controller 120 may deactivate the window selection signal SELj corresponding to each column (S21) when the present operation mode is not the fingerprint recognition mode FPR(S11: NO). Based on the deactivated window selection signal SELj, each conversion unit D/A may select the one or the gray voltages V0˜Vq corresponding to the received gray value (S22).

When the present operation mode is the fingerprint recognition mode FPR(S11: YES), the timing controller 120 may compare the row coordinate i of the target pixel with the boundary row coordinates NR1 and NR2 of the fingerprint recognition window FRW (S12). When the row coordinate i of the target pixel is not between the boundary row coordinates NR1 and NR2 (S12: NO), the timing controller 120 may deactivate the window selection signal SELj (S21) and the conversion unit D/A may select the gray voltage corresponding to the received gray value (S22).

When the row coordinate i of the target pixel is between the boundary row coordinates NR1 and NR2 (S12: YES), the timing controller 120 may compare the column coordinate j of the target pixel with the boundary column coordinates NC1 and NC2 of the fingerprint recognition window FRW (S13). When the column coordinate j of the target pixel is not between the boundary row coordinates NC1 and NC2 (S13: NO), the timing controller 120 may deactivate the window selection signal SELj (S21) and the conversion unit D/A may select the gray voltage corresponding to the received gray value (S22).

When the column coordinate j of the target pixel is between the boundary row coordinates NC1 and NC2 (S13: YES), the timing controller 120 may activate the window selection signal SELj (S31) and the conversion unit D/A may select the fingerprint recognition voltage VFR regardless of the received gray value (S32).

As such, according to example embodiments, the driving circuit may display the fingerprint recognition window based on the location of the fingerprint recognition window FRW and the location of a target pixel, among the plurality of pixels, in the fingerprint recognition mode. In at least one embodiment, the driving circuit may drive a data line of the target pixel with the fingerprint recognition voltage VFR, regardless of a gray value of display data, when the target pixel is in the fingerprint recognition window FRW. In contrast, the driving circuit may drive the data line of the target pixel with a gray voltage corresponding to a gray value of display data when the target pixel is not in the fingerprint recognition window.

As such, the fingerprint recognition window FRW of relatively high brightness may be displayed using the fingerprint recognition voltage VFR in the fingerprint recognition mode, and the image may be displayed on the portion of the display panel other than the fingerprint recognition window FRW using the gray voltage V0˜Vq in the normal operation mode.

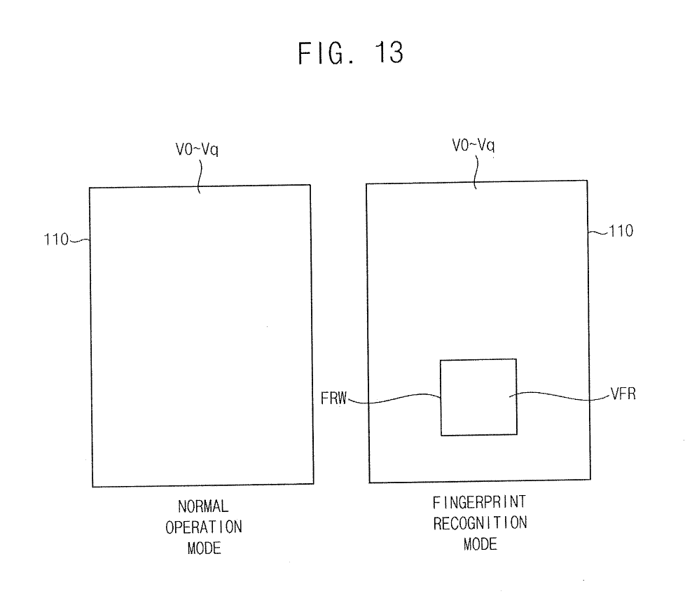

FIG. 13 illustrates an embodiment of driving voltages of a display panel in a normal operation mode and a fingerprint recognition mode. Referring to FIG. 13, in the normal operation mode, an image may be displayed on the display panel based on a first set of gray voltages V0˜Vq. In the fingerprint recognition mode, the fingerprint recognition window FRW may be displayed on a portion of the display panel 110 based on the fingerprint recognition voltage VFR and the image may be displayed on another portion of the display panel 110 based on the second set of gray voltages V0˜Vq.

As described with reference to FIGS. 5 to 13, the second set of gray voltages V0˜Vq in the fingerprint recognition mode may be identical to the first set of gray voltages V0˜Vq in the normal operation mode. As such, the electronic device and the method of performing optical fingerprint recognition according to example embodiments may increase the resolution of a fingerprint image, without degradation of a display image, by displaying the fingerprint recognition window of higher brightness using the fingerprint recognition voltage while maintaining the other gray voltages.

FIG. 14 illustrates an embodiment of gray voltages and a fingerprint recognition voltage. Referring to FIG. 14, in some example embodiments, the gray voltage may decrease as the gray value increases. For example, a minimum gray voltage V0 corresponding to a minimum brightness may have a highest voltage level and the maximum gray voltage Vq corresponding to a maximum brightness may have a lowest voltage level. In other example embodiments, for example, as described with reference to FIG. 6, the gray voltage may increase as the gray value increases.

A plurality of reference gray values RG0˜RGn may be selected among a plurality of gray values 0˜q and a plurality of gamma reference voltages VGR0˜VGRn corresponding to the plurality of reference gray values RG0˜RGn may be determined. A plurality of gray voltages corresponding to the plurality of gray values 0˜q may be provided based on the plurality of gamma reference voltages VGR0˜VGRn.

The gamma circuit 200 in the electronic device 100 of FIG. 2 may generate a first set of gamma reference voltages VGR0˜VGRn which includes the maximum gamma reference voltage VGRn corresponding to the maximum gray value “q” and may generate a first set of gray voltage V0˜Vq by dividing the first set of gamma reference voltages VGR0˜VGRn in the normal operation mode. Also, the gamma circuit 200 may generate a second set of gamma reference voltages VGR0˜VGRn−1 such that the maximum gamma reference voltage VGRn is replaced with a sub gamma reference voltage VGRn−1 corresponding to a sub gray value “q−1” less than the maximum gray value “q” by one, and may generate the second set of gray voltages V0˜Vq−1 by dividing the second set of gamma reference voltages VGR0˜VGRn−1 in the fingerprint recognition mode. The fingerprint recognition voltage VFR corresponding to the higher brightness than the maximum gray voltage Vq may be determined to be a lower voltage level than the maximum gray voltage Vq. As a result, the second set of gray voltages V0˜Vq−1 may be identical to the first set of gray voltages V0˜Vq except the maximum gray voltage Vq corresponding to the maximum gray value “q”.

As such, the electronic device and the method of performing optical fingerprint recognition according to example embodiments may increase the resolution of a fingerprint image, without degradation of a display image, by displaying the fingerprint recognition window FRW of higher brightness using the fingerprint recognition voltage VFR while maintaining the other gray voltages V0˜Vq−1.

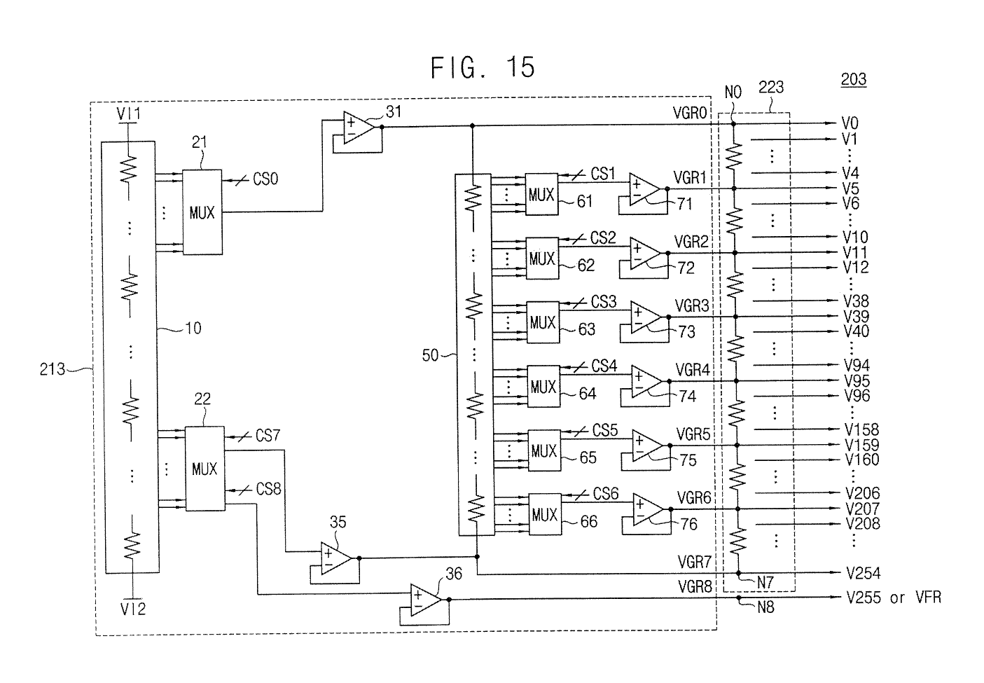

FIG. 15 illustrates another embodiment of a gamma circuit 203 which may include a gamma reference voltage generator 213 and a gray voltage generator 223. The gamma reference voltage generator 213 may include resistor strings 10 and 50, selectors MUX 21, 22, and 61˜66, and voltage buffers 31, 35, 36, and 71˜76 (which are connected, for example, as illustrated in FIG. 15) to generate a plurality of gamma reference voltages VGR0˜VGR8. The gamma reference voltages VGR0˜VGR7 except the maximum gamma reference voltage VGR8 may be maintained regardless of the operation modes. The maximum gamma reference voltage VGR8 may have different voltage level depending on the operation mode. The maximum gamma reference voltage VGR8 may have a voltage level corresponding to the maximum gray voltage V255 in the normal operation mode and a voltage level lower than the maximum gray voltage V255.

The gray voltage generator 223 may generate a plurality of gray voltages V0˜V254 by dividing the plurality of gamma reference voltages VGR0˜VGR7. FIG. 15 illustrates the gamma circuit 203 generating 256 gray voltages V0˜V255 corresponding to 8-bit display data. The number of gray voltages may be different in other embodiments, for example, depending on the bit number of the display data displayed by the display device. FIG. 15 illustrates the eight reference gray values 0, 5, 11, 39, 95, 159, 207, and 254 as an example. The number and/or values of the reference gray values may be different in other embodiments, for example, depending on characteristics of the display device.

The resistor string 10 may provide a plurality of voltages by dividing a first input voltage VI1 and a second input voltage VI2. The first input voltage VI1 and the second input voltage VI2 may be, for example, in the regulator voltage VREG in FIG. 2. The selectors 21 and 22 may select and output the gamma reference voltages VGR0, VGR7, and VGR8 corresponding to the selection signals CS0, CS7, and CS8 among the divided voltages from the resistor string 10. The gamma reference voltages VGR0, VGR7, and VGR8 may be buffered by voltage buffers 31, 35, and 36, which may be omitted in some example embodiments.

The voltage buffer 36 may output the maximum gamma reference voltage VGR8 having different voltage levels depending on the operation mode. The selector 22 may receive the selection signal CS 8 which may vary depending on the operation mode, such that the maximum gamma reference voltage VGR8 may correspond to the maximum gray voltage V255 on the gamma curve in the normal operation mode and may correspond to the fingerprint recognition voltage VGR lower than the maximum gray voltage V255.

As such, the maximum gray voltage V255 or the fingerprint recognition voltage VFR may be generated by changing the voltage level of the maximum gamma reference voltage VGR8 depending on the normal operation mode or the fingerprint recognition mode and the gamma reference voltages VGR0˜VGR7 regardless of the normal operation mode or the fingerprint recognition mode. As a result, the same gray voltages V0˜V254, except the maximum gray voltage V255, may be provided regardless of the operation mode.

The selectors 61˜66 may select and output the gamma reference voltages VGR1˜VGR6 corresponding to the selection signals CS1˜CS6, respectively, among the divided voltages, from the resistor string 50. The gamma reference voltages VGR1˜VGR6 may be buffered by voltage buffers 71˜76, which may be omitted according to some example embodiments.

The gray voltage generator 223 may generate the plurality of gray voltages VGR1˜VGR254 by dividing the gamma reference voltages VGR0˜VGR7 using the resistor string connected between the output node N0 of the minimum gamma reference voltage VGR0 and the output node N7 of the sub gamma reference voltage VGR7.

The voltage buffer 35, which outputs the sub gamma reference voltage corresponding to a sub gray value of 254, which is less than the maximum gray value 255 by one, may be referred to as a sub voltage buffer. The voltage buffer 36, which outputs the maximum gray voltage V255 in the normal operation mode and the fingerprint recognition voltage VFR in the fingerprint recognition mode, may be referred to as a maximum voltage buffer.

FIG. 15 illustrates an example embodiment in which the output node N7 of the sub voltage buffer 35 is electrically disconnected from the output node N8 of the maximum voltage buffer 36. In this case, the sub voltage buffer 35 may be enabled, both in the normal operation mode and in the fingerprint recognition mode, to generate the gray voltages V0˜V254 except the maximum gray voltage V255.

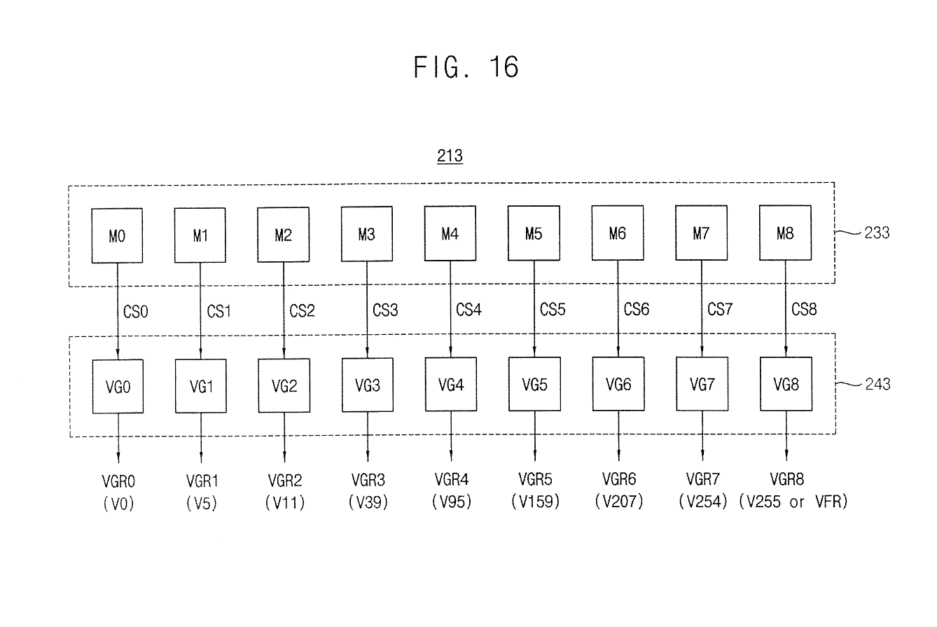

FIG. 16 illustrates another embodiment of a gamma reference voltage generator 213, which, for example, may corresponding to the gamma circuit of FIG. 15. The gamma reference voltage generator 213 may include a storage circuit 233 and a voltage generation circuit 243. FIG. 16 illustrates the nine reference gray values 0, 5, 11, 39, 95, 159, 207, 254, and 255, corresponding selection signals CS0˜CS8, and corresponding gamma reference voltages VGR0˜VGR8 as an example. The number and values of the reference gray values may be different, for example, depending on characteristics of the display device.

Referring to FIG. 16, the storage circuit 233 may include a plurality of memory units M0˜M8 to store values corresponding to the gamma reference voltages VGR0˜VGR8. The voltage generation circuit 243 may include a plurality of voltage generation units VG0˜VG8 to generate the gamma reference voltages VGR0˜VGR8 based on the selection signals CS0˜CS8 from the storage circuit 233. The voltage generation units VG0˜VG8 may include resistor strings and selectors, for example, as described with reference to FIG. 15. In one embodiment, the voltage generation unit VGR7 which generates the sub gamma reference voltage VGR7 may include the sub voltage buffer 35 in FIG. 15. The voltage generation unit VGR8 may include the maximum voltage buffer 36 in FIG. 15. The voltage generation unit VG8 may generate the maximum gray voltage V255 in the normal operation mode and the fingerprint recognition voltage VFR in the fingerprint recognition mode based on the varying selection signal CS8.

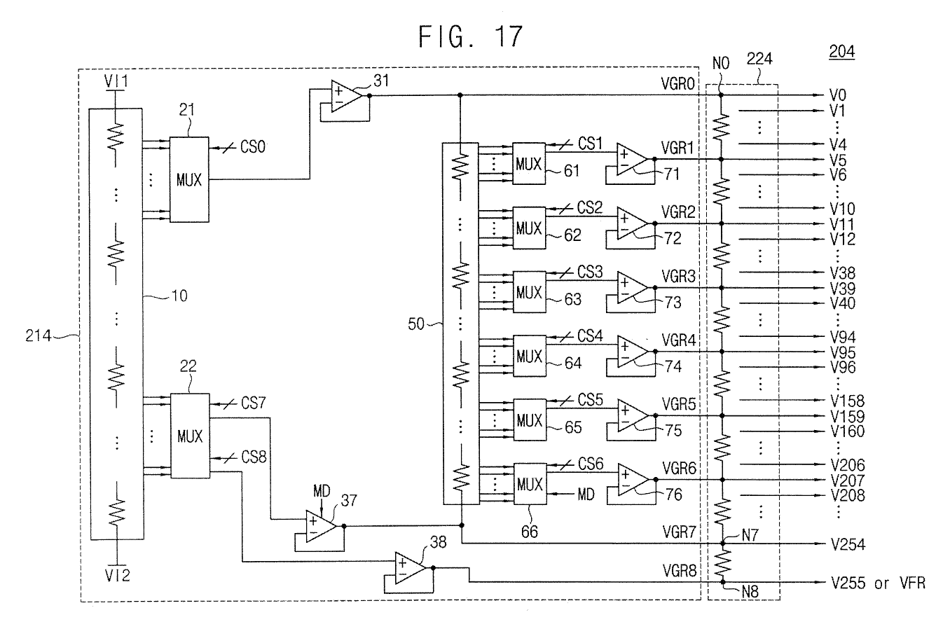

FIG. 17 illustrates another embodiment of a gamma circuit 204 which may include a gamma reference voltage generator 214 and a gray voltage generator 224. The gamma circuit 204 of FIG. 15 may be similar to the gamma circuit 203 of FIG. 15, except as follows.

The output node N7 of the sub voltage buffer 35 and the output node N8 of the maximum voltage buffer V36 are electrically disconnected from each other in the gamma circuit 203 of FIG. 15. In contrast, the output node N7 of the sub voltage buffer 37 and the output node N8 of the maximum voltage buffer V38 are electrically connected to each other through a resistor in the gamma circuit 204 of FIG. 17. In this case, the sub voltage buffer 37 is disabled in the normal operation mode and enabled in the fingerprint recognition mode.

In the normal operation mode, the sub voltage buffer 37 may be disabled and the maximum gamma reference voltage VGR8 or the maximum gray voltage V255 may be used to generate the other gray voltages V0˜V254. In contrast, in the fingerprint recognition mode, the sub voltage buffer 37 may be enabled to drive the sub gamma reference voltage VGR7 or V254 such that the fingerprint recognition voltage VFR from the maximum voltage buffer 38 may not effect on the gray voltages V0˜V254.

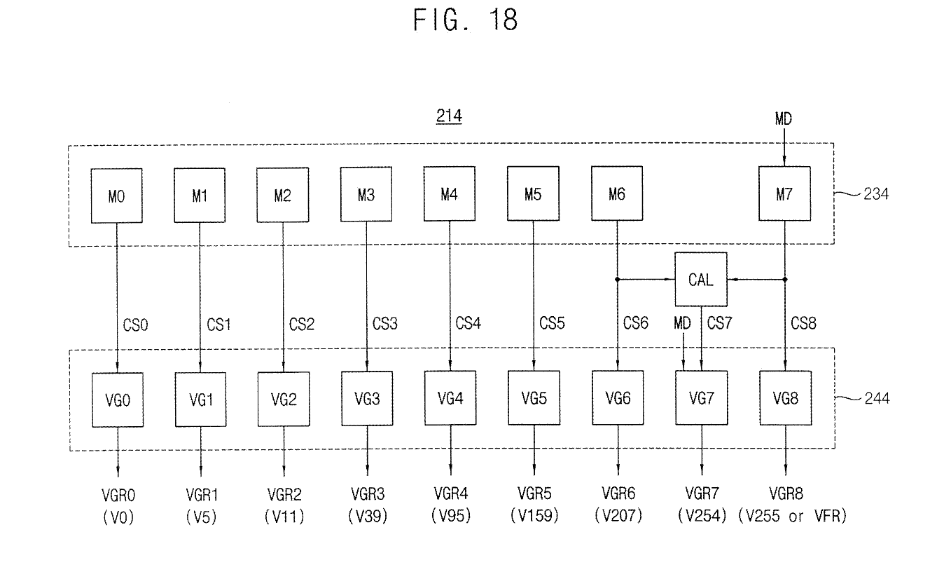

FIG. 18 illustrates an embodiment of a gamma reference voltage generator 214, which, for example, may correspond to the gamma circuit of FIG. 17.

Referring to FIG. 18, the gamma reference voltage generator 214 may include a storage circuit 234 and a voltage generation circuit 244. The gamma reference voltage generator 214 of FIG. 18 may be similar to the gamma reference voltage generator 213 of FIG. 16, except as follows.

In comparison with the gamma reference voltage generator 213 of FIG. 16, the gamma reference voltage generator 214 of FIG. 18 omits the memory unit for storing the value of the selection signal CS7 and may include a calculator CAL. As described above, the voltage generation unit VG7 may be disabled in the normal operation mode and enabled in the fingerprint recognition mode based on the mode signal MD. The calculator CAL may provide a selection control value CS7 of the sub gamma reference voltage VGR7 based on selection control values CS6 and CS8 of the gamma reference voltages VGR6 and VGR8 near the sub gamma reference voltage VGR7 in the fingerprint recognition mode. For example, the calculator CAL may receive the selection control values CS6 and CS8 corresponding to the gamma reference voltages VGR6 and VGR 8 (e.g., the gray voltages V207 and V255 on the gamma curve) from the adjacent memory units M6 and M7 and perform an interpolation operation based on the gray values corresponding to the CS6 and CS8 to provide the selection control value CS7 corresponding to the sub gamma reference voltage VGR7.

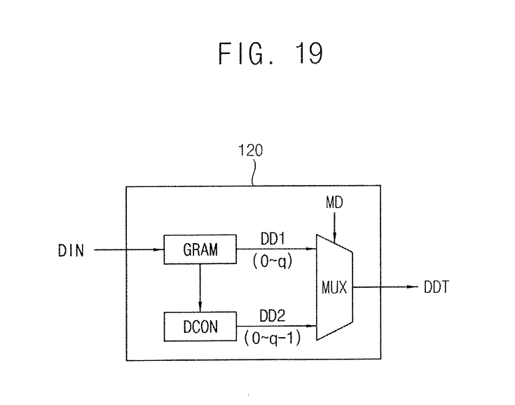

FIG. 19 an embodiment of a circuit for processing display data. Referring to FIG. 19, the circuit includes a timing controller 120 that may include a data buffer GRAM, a data converter DCON, and a multiplexer MUX. The data buffer GRAM may be, for example, a frame buffer to store a signal frame of the display data and the data buffer GRAM may store input data DIN by units of a frame.

The data buffer GRAM may store and output first display data DD1 in a range from the minimum gray value “0” to the maximum gray value “q”. The data converter DCON may convert the first display data DD1 to second display data DD2 having a range from the minimum gray voltage “0” to the sub gray value “q−1”. The multiplexer MUX may select and one of the first display data DD1 and the second display data DD2 based on the mode signal MD and output the selected one as the display data DDT. The multiplexer MUX may output the first display data DD1 in the range 0˜q as the display data DDT in the normal operation mode and output the second display data DD2 in the range 0˜q−1 as the display data DDT in the fingerprint recognition mode.

In some example embodiments, the data converter DCON may perform a process for replacing, among the second display data DD2, gray values of the pixels corresponding to the fingerprint recognition window FRW with the maximum gray value “q”. The replacement of the gray values for displaying the fingerprint recognition window FRW may be performed, for example, by the timing controller 120 in FIG. 2. In some example embodiments, the replacement of the gray value and/or the reduction of the range of the gray values may be performed by another component external to the timing controller 120.

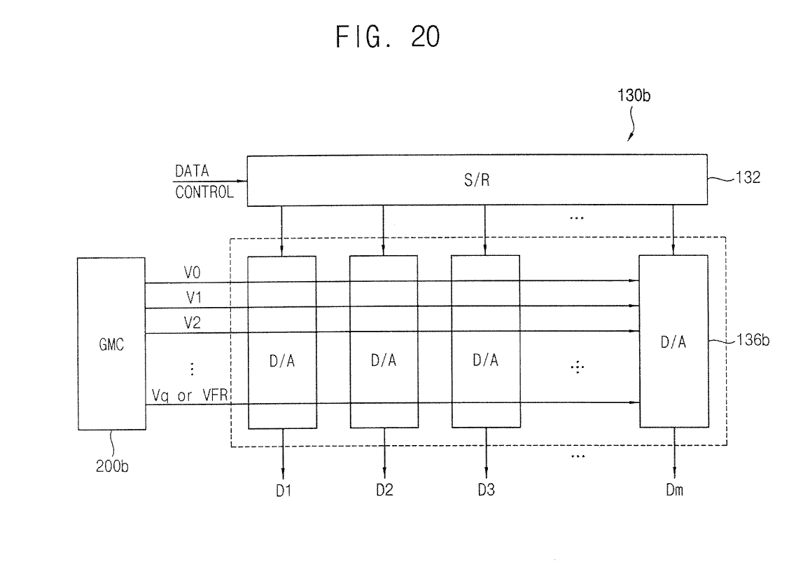

FIG. 20 illustrates another example embodiment of a data driver 130, which, for example, may be included in the electronic device of FIG. 2.

Referring to FIG. 20, the data driver 130b may include a shift register S/R 132 and a digital-to-analog converter 136b. The data driver 130b of FIG. 20 may be similar to the data driver 130a of FIG. 10, except as follows.

The digital-to-analog converter 136b may include a plurality of conversion units D/A for receiving the gray voltages V0˜Vq and the fingerprint recognition voltage VFR, respectively. Each conversion unit D/A may select, among the gray voltages V0˜Vq, the one gray voltage corresponding to the digital data bit received from the shift register 132. In the embodiment of FIG. 20, the maximum gray voltage Vq may be provided in the normal operation mode and the fingerprint recognition voltage VFR may be provided in the fingerprint recognition mode, through the voltage line corresponding to the maximum gray voltage Vq.

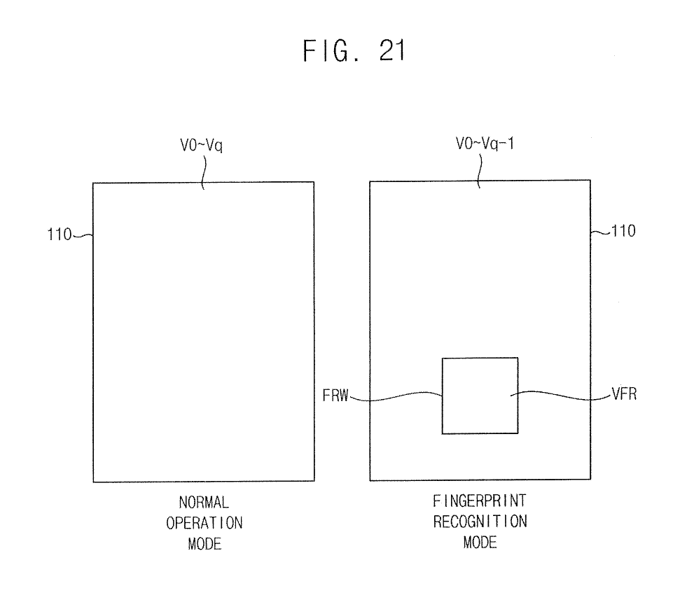

FIG. 21 illustrates an embodiment of driving voltages of a display panel in a normal operation mode and a fingerprint recognition mode. Referring to FIG. 21, in the normal operation mode, an image may be displayed on the display panel based on a first set of gray voltages V0˜Vq. In the fingerprint recognition mode, the fingerprint recognition window FRW may be displayed on a portion of the display panel 110 based on the fingerprint recognition voltage VFR and the image may be displayed on the other portion of the display panel 110 based on the second set of gray voltages V0˜Vq−1.

As described with reference to FIGS. 14 to 20, the second set of gray voltages V0˜Vq−1 in the fingerprint recognition mode may be maintained identical to the first set of gray voltages V0˜Vq in the normal operation mode, except the maximum gray voltage Vq. As such, the electronic device and the method of performing optical fingerprint recognition according to example embodiments may increase the resolution of a fingerprint image, without degradation of a display image, by displaying the fingerprint recognition window of higher brightness using the fingerprint recognition voltage while maintaining the other gray voltages V0˜Vq−1.

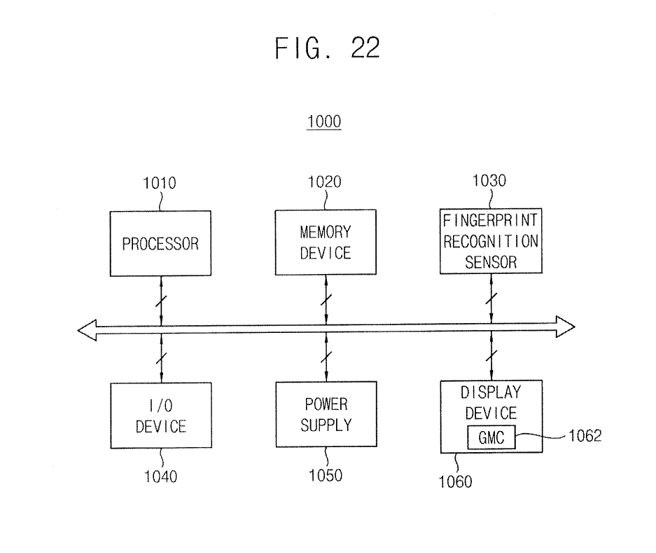

FIG. 22 illustrates another embodiment of an electronic device 1000 which may include a processor 1010, a memory device 1020, a fingerprint recognition sensor 1030, an input/output (I/O) device 1040, a power supply 1050, and a display device 1060. The electronic device 1000 may further include, for example, a plurality of ports for communicating a video card, a sound card, a memory card, a universal serial bus (USB) device, other electronic devices, and/or other features.

The processor 1010 may perform various computing functions. The processor 1010 may be a micro-processor, a central processing unit (CPU), or another type of processor. The processor 1010 may be coupled to other components via an address bus, a control bus, a data bus, and/or other components. Further, the processor 1010 may be coupled to an extended bus such as a peripheral component interconnection (PCI) bus. The memory device 1020 may store data for operations of the electronic device 1000.

The I/O device 1040 may be an input device such as a keyboard, a keypad, a mouse, a touchpad, a touch-screen, a remote controller, etc., and an output device such as a printer, a speaker, etc. The power supply 1050 may provide a power for operations of the electronic device 1000.

According to example embodiments, the display device 1060 may include a gamma circuit GMC 1062 as described above. The gamma circuit 1062 may generate a first set of gray voltages in a normal operation mode and a fingerprint recognition voltage corresponding to a brightness higher than a maximum gray voltage among the first set of gray voltages. The display device 1060 may display the fingerprint recognition window of higher brightness using the fingerprint recognition voltage for receiving light reflected by a fingerprint of a user. The fingerprint recognition sensor 1030 may recognize the fingerprint based on the reflection light of the fingerprint received through the fingerprint recognition window.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods herein.

The controllers, processors, generators, calculators, multiplexers, dividers, converters, and other signal generating, providing, and processing features of the embodiments disclosed herein may be implemented in non-transitory logic which, for example, may include hardware, software, or both. When implemented at least partially in hardware, the controllers, processors, generators, calculators, multiplexers, dividers, converters, and other signal generating, providing, and processing features may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the controllers, processors, generators, calculators, multiplexers, dividers, converters, and other signal generating, providing, and processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

In accordance with one or more of the aforementioned embodiments, the electronic device and the method of performing optical fingerprint recognition may increase the intensity of light reflected by a fingerprint and may increase the resolution of a fingerprint image by displaying the fingerprint recognition window of higher brightness based on the fingerprint recognition voltage. In addition, the electronic device and the method of performing optical fingerprint recognition may increase the resolution of a fingerprint image, without degradation of a display image, by displaying the fingerprint recognition window of higher brightness based on the fingerprint recognition voltage while maintaining the other gray voltages.

The embodiments described herein may be applied to any devices and systems including a display device. For example, the embodiments described herein may be applied to systems such as be a mobile phone, a smart phone, a personal digital assistant (PDA), a portable multimedia player (PMP), a digital camera, a camcorder, personal computer (PC), a server computer, a workstation, a laptop computer, a digital TV, a set-top box, a portable game console, a navigation system, etc.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, various changes in form and details may be made without departing from the spirit and scope of the embodiments set forth in the claims.

What is claimed is:

1. An electronic device, comprising:
a display panel including a plurality of pixels;
a gamma circuit to generate a first set of gray voltages in a normal operation mode and to generate a fingerprint recognition voltage corresponding to a brightness higher than a maximum gray voltage among the first set of gray voltages in a fingerprint recognition mode;
a driving circuit to display an image on the display panel based on the first set of gray voltages in the normal operation mode and to display a fingerprint recognition window on a portion of the display panel based on the fingerprint recognition voltage in the fingerprint recognition mode; and
a fingerprint recognition sensor to recognize a fingerprint based on reflected light of the fingerprint received through the fingerprint recognition window.

2. The electronic device as claimed in claim 1, wherein:
the gamma circuit is to generate a second set of gray voltages in the fingerprint recognition mode, and
the driving circuit is to display an image on a portion of the display panel other than the fingerprint recognition window based on the second set of gray voltages in the fingerprint recognition mode.

3. The electronic device as claimed in claim 2, wherein the second set of gray voltages equal the first set of gray voltages.

4. The electronic device as claimed in claim 3, wherein the gamma circuit is to generate:
a plurality of gamma reference voltages common to the normal operation mode and the fingerprint recognition mode, and
the first set of gray voltages and the second set of gray voltages by dividing the plurality of gamma reference voltages.

5. The electronic device as claimed in claim 4, wherein the gamma circuit is to generate the plurality of gamma reference voltages and the fingerprint recognition voltage based on a first input voltage and a second input voltage.

6. The electronic device as claimed in claim 4, wherein the gamma circuit is to generate:
the plurality of gamma reference voltages based on a first input voltage and a second input voltage, and
the fingerprint recognition voltage based on a third input voltage that is to be provided independently of the first input voltage and the second input voltage.

7. The electronic device as claimed in claim 2, wherein the driving circuit is to display the fingerprint recognition window based on a location of the fingerprint recognition window and a location of a target pixel among the plurality of pixels in the fingerprint recognition mode.

8. The electronic device as claimed in claim 7, wherein the driving circuit is to drive a data line of the target pixel with the fingerprint recognition voltage regardless of a gray value of display data when the target pixel is in the fingerprint recognition window.

9. The electronic device as claimed in claim 7, wherein the driving circuit is to drive a data line of the target pixel with a gray voltage, among the second set of gray voltages corresponding to a gray value of display data, when the target pixel is not in the fingerprint recognition window.

10. The electronic device as claimed in claim 2, wherein the second set of gray voltages are equal to the first set of gray voltages except a maximum gray voltage corresponding to a maximum gray value.

11. The electronic device as claimed in claim 10, wherein the gamma circuit is to generate:
a first set of gamma reference voltages including a maximum gamma reference voltage corresponding to the maximum gray value and the first set of gray voltages by dividing the first set of gamma reference voltages in the normal operation mode, and
a second set of gamma reference voltages such that the maximum gamma reference voltage is replaced with a sub gamma reference voltage corresponding to a sub gray value less than the maximum gray value by one, and the second set of gray voltages by dividing the second set of gamma reference voltages in the fingerprint recognition mode.

12. The electronic device as claimed in claim 11, wherein the gamma circuit includes:
a sub voltage buffer to generate the sub gamma reference voltage; and
a maximum voltage buffer to generate the maximum gray voltage in the normal operation mode and the fingerprint recognition voltage in the fingerprint recognition mode.

13. The electronic device as claimed in claim 12, wherein:
an output node of the sub voltage buffer is to be electrically disconnected from an output node of the maximum voltage buffer, and
the sub voltage buffer is to be enabled both in the normal operation mode and in the fingerprint recognition mode.

14. The electronic device as claimed in claim 12, wherein:
an output node of the sub voltage buffer is to be electrically connected to an output node of the maximum voltage buffer through a resistor, and
the sub voltage buffer is to be disabled in the normal operation mode and enabled in the fingerprint recognition mode.

15. The electronic device as claimed in claim 14, wherein the gamma circuit includes a calculator to provide a selection control value of the sub gamma reference voltage based on selection control values of the gamma reference voltages near the sub gamma reference voltage in the fingerprint recognition mode.

16. The electronic device as claimed in claim 11, wherein driving circuit includes:
a data converter to convert first display data in a range from a minimum gray value to the maximum gray value to second display data in a range from the minimum gray value to the sub gray value.

17. The electronic device as claimed in claim 16, wherein the data converter is to replace, among the second display data, gray values of the pixels corresponding to the fingerprint recognition window with the maximum gray value.

18. A gamma circuit for generating gray voltages to drive a display panel, comprising:
a generator to generate a first set of gray voltages in a normal operation mode and a second set of gray voltages and a fingerprint recognition voltage in a fingerprint recognition mode, wherein the fingerprint recognition voltage corresponds to a brightness higher than a maximum gray voltage among the first set of gray voltages in the fingerprint recognition mode.

19. The gamma circuit as claimed in claim 18, wherein the generator is to generate the second set of gray voltages based on a sub gamma voltage corresponding to a sub gray value less than a maximum gray value by one in the fingerprint recognition mode.

20. A method for performing optical fingerprint recognition, the method comprising:
generating a plurality of gray voltages to display an image on a display panel based on the plurality of gray voltages in a normal operation mode;
generating a fingerprint recognition voltage corresponding to a brightness higher than a maximum gray voltage among the plurality of gray voltages in a fingerprint recognition mode;
displaying a fingerprint recognition window on a portion of the display panel based on the fingerprint recognition voltage in the fingerprint recognition mode; and
recognizing a fingerprint based on a reflection light of the fingerprint received through the fingerprint recognition window.
